(19) United States
(12) Patent Application Publication
(10) Pub. No.: US 2004/0207755 A1
(43) Pub. Date: Oct. 21, 2004

(54) APPARATUS AND METHOD FOR SIGNAL PRCOESSING OF FORMAT CONVERSION AND COMBINATION OF VIDEO SIGNALS

(76) Inventor: Tzu-Ping Lin, Ping-Tung Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/709,147

(22) Filed: Apr. 16, 2004

(30) Foreign Application Priority Data
Apr. 17, 2003 (TW) 092108997

(51) Int. Cl. H04N 5/268; H04N 11/20

(52) U.S. Cl. 348/453; 348/441

(57) ABSTRACT

A method is disclosed for converting and mixing a plurality of video data without data loss. The video data have a plurality of sampling formats, and the sampling formats at least comprise a high chrominance-sampling-rate format and a low chrominance-sampling-rate format. The method includes receiving a first video data in the low chrominance-sampling-rate format and a second video data in the high chrominance-sampling-rate format, converting the first video data in the low chrominance-sampling-rate format into a first video data in the high chrominance-sampling-rate format, and mixing the first video data in the high chrominance-sampling-rate format with the second video data in the high chrominance-sampling-rate format for generating a mixed video data in the high chrominance-sampling-rate format.

### BACKGROUND OF INVENTION

1. Field of the Invention

The invention relates to an apparatus and a method for converting and mixing video data, and more particularly, to an apparatus and a method for converting video data in low chrominance-sampling-rate format into video data in high chrominance-sampling-rate format and mixing the converted video data with another video data in high chrominance-sampling-rate format to prevent video quality deterioration.

2. Description of the Prior Art

Motion pictures expert group MPEG-1 standard and the newer MPEG-2 standard are commonly used for the playback of digital multimedia data, e.g. movies and animations, stored in CD discs or DVD-ROM discs. In addition, the above-mentioned standards are applied to a high definition digital television (HDTV) for performing the video compression with high quality and high efficiency. MPEG-1 is the first standard introduced by the MPEG organization. This MPEG-1 standard is used for compressing 30 frames with a video resolution of 320×240 into a video data stream transmitted at approximately 1.2 Mbps and for compressing stereo audio data into an audio data stream transmitted at approximately 250 kbps. The audio and video data streams are blended together into a video clip played at approximately 1.5 Mpbs, which is generally stored in a CD disc and reproduced with a 2× CD-Player. MPEG-2 standard further improves the MPEG-1 standard not only in video and audio quality, but also in providing additional features such as multi-lingual, multi-subtitle, multi-angle, movie rating, and the like. In terms of audio quality, MPEG-2 standard adapts a similar audio compression method compatible with MPEG-1 standard, and adds an advanced audio coding (AAC) technique having a high compression ratio. Concerning the picture quality, MPEG-2 standard is capable of processing video frames with a video resolution of 720×480, and implements some new video compression techniques and video sampling formats to improve the picture clarity and to provide a better compression ratio.

Compression is basically a process for eliminating the repeated portions in audio and video (AV) data so as to reduce the capacity occupied by the AV data. By the way, it is well-known that the video data generally has many negligible elements. During compression, i.e. the process of removing the negligible elements, the important elements in the AV data is first identified while the rest that is repetitive and unimportant is removed. Experiments prove that the human eye is more sensitive to luminosity but not quite reactive to chrominance variance. As a result, MPEG-2 standard utilizes two factors: luminance and chrominance as the color representation format, where Y represents the luminance and C represents the chrominance (C including CB and CR for further distinguishing a first chrominance and a second chrominance). The original color signals R, G, and B are converted into luminance Y and chrominance CB, CR before encoding the video data. Because reducing the chrominance information can effectively shrink the data size while minimizing the degradation in picture quality, the MPEG-2 standard takes advantage of this feature to reduce the number of samples of the chrominance.

MPEG-2 standard defines three predefined sampling format: 4:2:0, 4:2:2, and 4:4:4, which represent different sampling frequencies of the chrominance. The 4:2:0 sampling format means one chrominance value CR and one chrominance value CB are sampled when four luminance values are extracted. The digital video data stored in a CD-ROM or a DVD-ROM for displaying a main-picture has the 4:2:2 sampling format. The 4:2:2 sampling format means two chrominance values CR and two chrominance values CB are sampled when four luminance values are extracted. For the 4:4:4 sampling format, it means that four chrominance values CR and four chrominance values CB are sampled when four luminance values are extracted. That is, no chrominance reduction is performed if the 4:4:4 sampling format is used.

Please refer to FIG. 1, which is a schematic diagram illustrating luminance Y and chrominance C of a graphical layout 10 in a 4:2:0 sampling format according to the prior art. The graphical layout 10 includes a plurality of pixels 11 (sampling points), wherein a sampled pixel value of each pixel includes luminance Y, chrominances CB, CR, or any combination of luminance Y and chrominances CB, CR. Each mark O shown in FIG. 1 represents a sampled luminance value Y and each mark X shown in FIG. 1 represents a sampled chrominance value CB or CR. The graphical layout 10 is consisted of a plurality of lines 18. The mark O representing the sampled luminance value and the mark X representing the sampled chrominance value are individually shown in FIG. 1 for clarity. For the 4:2:0 sampling format, the graphical layout 10 has an identical sampling rate both in the vertical direction (arrow 12) and the horizontal direction (arrow 14). In addition, the sampling rate of the luminance to the sampling rate of the chrominance in either the vertical direction or the horizontal direction corresponds to a ratio equaling 2:1. In other words, the sampling rate of the luminance is 4 times as great as the sampling rate of the chrominance. Furthermore as shown in FIG. 1, an image block 16 with four sampled luminance values clearly demonstrates that every four sampled luminance values Y correspond to one sampled chrominance value C (one chrominance value CR or one chrominance value CB) according to the 4:2:0 sampling format. During the transmission and processing of video data, for the graphical layout 10, the sampling point is scanned line by line in the horizontal direction according to the arrow 14. Under this mode, the shortcomings of the 4:2:0 sampling format is entirely exposed. As shown in FIG. 1, one of every two lines has no sampling point X for chrominance CB, CR which significantly affects the vertical color resolution of the chrominance. Due to this flaw in this sampling format, a vertical interpolation is applied to the sampled chrominance value for recovering the missing chrominance C.

Please refer to FIG. 2, which is schematic diagram illustrating the luminance Y and chrominance C of a graphical layout 20 in a 4:2:2 sampling format according to the prior art. The graphical layout 20 also has a plurality of pixels 21 (sampling points), wherein the sampled pixel value of each pixel 21 includes luminance Y, chrominance CB, CR, or any combination of luminance Y and chrominance CB, CR. Similarly, the mark O represents a sampled luminance value Y, and the mark X represents a sampled chrominance value CB or CR. In addition, the graphical layout 20 is consisted of a plurality of lines 28. In the current standard, the sampling rate of the luminance Y is 13.5 MHz for the 4:2:2 sampling format, and the sampling rate of each chrominance CR, CB is 6.75 MHz for the 4:2:2 sampling format. After the some the above-mentioned missing chrominance values C are added, an image block 26 has four luminance values Y and two chrominance values C (two chrominance values CR and two chrominance values CB) according to the 4:2:2 sampling format.

Please refer to FIG. 3, which is a schematic diagram illustrating the luminance Y and chrominance C of a graphical layout 30 in a 4:4:4 sampling format according to the prior art. The graphical layout 30 is consisted of a plurality of lines 38. The graphical layout 30 includes a plurality of pixels 31 (sampling points), wherein the pixel value of each pixel simultaneously includes luminance (the marks O shown in FIG. 3) and two chrominances CB, CR (the marks X shown in FIG. 3). One image block 36 in 4:4:4 sampling format, therefore, includes four luminance values Y, four chrominance values CR, and four chrominance values CB. That is, no reduction of sampling points for the chrominance is performed.

As previously described, the video data stored in the digital storage multimedia (e.g. CD-ROMs or DVD-ROMs) for displaying the main-picture have the 4:2:2 sampling format, but video data for displaying the sub-picture (SP) and the on-screen display (OSD) have the 4:4:4 sampling format. A prior art MPEG-2 decoder implemented on a DVD player is connected to an external TV encoder through an interface complying with the CCIR standard (currently renamed as the ITU standard). The interface is just capable of transferring MPEG-2 video data in the 4:2:2 sampling format. Therefore, the SP and OSD video data in the 4:4:4 sampling format cannot be directly transmitted via the interface. As a result, the video data need to be converted into video data in the 4:2:2 sampling format before being transmitted to the TV encoder. In addition, before the video data of the main-picture in the 4:4:2 sampling format is mixed with the video data of the SP in the 4:4:4 sampling format, the SP video data in 4:4:4 sampling format is first converted into SP video data in 4:2:2 sampling format and then mixed with the main-picture video data in 4:2:2 sampling format. In the end, the mixed video data can be successfully delivered to the TV encoder through the above-mentioned interface. The aforementioned video data processing methods and related structures are described in some publications and patents. In U.S. Pat. No. 5,489,947 “On screen display arrangement for a digital video signal processing system”, Cooper et al teaches to convert an SP video data in 4:4:4 sampling format into an SP video data in 4:2:2 sampling format and then mix the converted SP video data with a main-picture video data in 4:2:2 sampling format to achieve the video data mixing of different sampling formats. In another U.S. Pat. No. 6,529,244 “Digital video decode system with OSD processor for converting graphics data in 4:4:4 sampling format to 4:2:2 sampling format by mathematically combining chrominance”, Hrusecky et al teaches to convert an OSD video data in 4:4:4 sampling format into an OSD video data in 4:2:2 sampling format and then mix the converted OSD video data with a main-picture video data in 4:2:2 sampling format to complete the video data mixing.

Please refer FIG. 4, which is a block diagram of a prior art video data processing device 40. FIG. 4 illustrates the basic structure disclosed by the U.S. Pat. No. 5,489,947 and U.S. Pat. No. 6,529,244. The video data processing device 40 includes a main-picture data receiving end 42, an SP data receiving end 44, a 4:4:4 to 4:2:2 sampling format converter 46, a data mixer 48, and an external TV encoding module 50. The channel interface (CI) between the data mixer 48 and the TV encoding module 50 complies with the CCIR (or ITU) standard. When the main-picture data receiving end 42 receives video data in 4:2:2 sampling format, the main-picture in 4:2:2 sampling format, as shown in FIG. 4, includes a main luminance value Ym and a main chrominance value Cm. Please at the same time refer to FIG. 5, which is a schematic diagram showing a plurality of luminance values and chrominance values of a plurality of video data shown in FIG. 4. FIG. 5 shows the main-picture video data with the main luminance value Ym and the main chrominance value Cm respectively transmitted in two different channels. The data stream of the main luminance Ym is formed by a plurality of main luminance values Ym0, Ym1, Ym2, Ym3 corresponding to different sampling points. The data stream of the main chrominance Cm is formed by a plurality of main chrominance values CRm0, CRm1, CRm2, CRm3 corresponding to different sampling points. As mentioned before, the sampling rate of the chrominance C (CR and CB) is half the sampling rate of the luminance according to the 4:2:2 sampling format. Therefore, the main chrominance values CBm0 and Crm0 are acquired from the same sampling point corresponding to the main luminance value Ym0, or are average values of main luminance values of adjacent sampling points. Similarly, the main chrominance values CBm2, CRm2 and the luminance value Ym2 are considered to be taken from the same sampling point or to be respectively assigned by an average value of the luminance values and average values of the chrominance values of adjacent sampling points. The SP data receiving end 44 shown in FIG. 4 is used to receive the SP video data in 4:4:4 sampling format, wherein the SP video data in 4:4:4 sampling format includes a sub luminance Ys, a first sub chrominance CBs, and a second sub chrominance CRs. As disclosed in FIG. 5, every sampling point includes a sub luminance Ys, a first sub chrominance CBs, and a second sub chrominance CRs with no reduction imposed on sampling points of the chrominance. For instance, the sub luminance Ys0, the first sub chrominance CBs0, and the second sub chrominance CRs0 correspond to the same sampling point.

Please refer to FIG. 4, the 4:4:4 to 4:2:2 sampling format converter 46 is electrically connected to the SP data receiving end 44 to perform a down-sampling processing for converting the SP data in 4:4:4 sampling format into the SP video data in 4:2:2 sampling format. The down-sampling processing reduces the number of sampled chrominance values to achieve data compression. The sub luminance Ys of the SP video data in 4:4:4 sampling format is intact after the down-sampling processing is completed. However, the 4:4:4 to 4:2:2 sampling format converter 46 will process the first sub chrominance CBs and the second sub chrominance CRs. Please refer to FIG. 5, which is a schematic diagram illustrating two difference prior art reduction methods A and B. The prior art reduction method A alternatively discards a first sub chrominance CBs and a second sub chrominance CRs as the sampling points are sequentially processed. In this example, chrominance values CRs0, CRs1, CRs2 are discarded to reduce half of the chrominance information. The prior art reduction method B discards a first sub chrominance CBs and a second sub chrominance CRs of one sampling point between two adjacent sampling points. Then, the non-discarded second sub chrominance CRs of the sampling point prior to the currently processed sampling point is annexed to the first chrominance CBs of the sampling point prior to the currently processed sampling point for forming the wanted data stream. The SP video data processed by the 4:4:4 to 4:2:2 sampling format converter 46 have the 4:2:2 sampling format, and includes a sub luminance Ys with an original value and a sub chrominance Cs. The sub chrominance Cs is the result generated from the first sub chrominance CBs and the second sub chrominance CRs processed by either the prior art reduction method A or the prior art reduction method B. The data mixer 48 electrically connected to the 4:4:4 to 4:2:2 sampling format converter 46 and the main-picture data receiving end 42 is used for mixing the main-picture video data in 4:2:2 sampling format with the SP video data in 4:2:2 sampling format to output a mixed video data in 4:2:2 sampling format. The mixed video data in 4:2:2 sampling format includes a luminance Yg and a chrominance Cg. FIG. 5 also shows the luminance Yg and chrominance Cg sequentially transmitted in two different channels, respectively.

The main-picture data receiving end 42 shown in FIG. 4 has another 4:4:0 to 4:2:2 sampling format converter 47 for converting the main-picture data in 4:2:0 sampling format stored in an optical disc such as a VCD disc or a DVD disc into a main-picture data in 4:2:2 sampling format. Furthermore, the external TV encoding module 50 includes one 4:2:2 to 4:4:4 sampling format converter 49 and one TV encoder 51. In this embodiment, the video data inputted into the TV encoder 51 comply with the 4:4:4 sampling format. In other words, the 4:2:2 to 4:4:4 sampling format converter 49 is capable of performing an up-sampling processing to convert the received mixed data in 4:2:2 sampling format into the mixed data in 4:4:4 sampling format. The mixed data in 4:4:4 sampling format include one mixed luminance Yg, one first mixed chrominance CBg, and one second mixed chrominance CRg. In the end, the TV encoder 51 converts the mixed data in 4:4:4 sampling format into the well-known TV video signal Ts.

The prior art apparatus and methods for converting and mixing video data in different sampling formats cause color degradation in high resolution SP video because a certain amount of chrominance information is discarded during the conversion from the 4:4:4 sampling format to the 4:2:2 sampling format. Please refer to FIG. 5 again. When the reduction method A is used to alternatively discard either one first sub chrominance CBs or one second sub chrominance CRs of every processed sampling point, the original chrominance values CRs0, CBs1, CRs2, CBs3 are replaced by the replicated chrominance values CBs0, Crs1, CBs2, CRs3 during the reestablishment of the missing first chrominance CB and the missing second chrominance CR, that is, the up-sampling processing performed by the 4:2:2 to 4:4:4 sampling format converter 49. Take the sampling point corresponding to the luminance Ys0 as an example. Because the chrominance value CBs0 is discarded, a replicated chrominance value CRs1 is assigned to the chrominance value CBs0. Therefore, the final color is displayed according to a mixed chrominance value of the chrominance values CBs0 and CRs1 instead of the original combination of chrominance values CBs0 and CRs0. It is obvious that the color of the sampling point (pixel) is erroneously shown. Concerning the prior art reduction method B, it discards the first sub chrominance CBs and the second sub chrominance CRs of every other sampling point. The discarded chrominance values cannot be recovered. Therefore, the color degradation becomes more significant. In addition, the color degradation is amplified on the tiny subtitle images and at edges of image objects, which becomes visually obvious. Even the current technology allows the TV encoding module 50 or TV encoder 51 shown in FIG. 4 to be fabricated in the same DVD (or VCD) playback chip, which avoids the CCIR (or ITU) interface. However, the color degradation due to the lose of data is yet to be solved.

### SUMMARY OF INVENTION

It is therefore a primary objective of the claimed invention to provide an apparatus and a method for converting and mixing video data in different sampling formats to solve the above-mentioned problem.

The present invention discloses a device for converting and mixing a plurality of video data. The video data have a plurality of sampling formats, and the sampling formats at least comprise a high chrominance-sampling-rate format and a low chrominance-sampling-rate format. The claimed device has a first data receiving end for receiving a first video data in the low chrominance-sampling-rate format; a second data receiving end for receiving a second video data in the high chrominance-sampling-rate format; a format converting module electrically connected to the first data receiving end for up-sampling the first video data to convert the first video data in the low chrominance-sampling-rate format into a first video data in the high chrominance-sampling-rate format; and a data mixer electrically connected to the format converting module and the second data receiving end for mixing the first video data in the high chrominance-sampling-rate format with the second video data in the high chrominance-sampling-rate format to generate a mixed video data in the high chrominance-sampling-rate format.

The present invention further discloses a video data processing device. The claimed video data processing device has a main-picture video data receiving end for receiving a main-picture video data in a 4:2:2 sampling format, wherein the main-picture video data in the 4:2:2 sampling format comprises a main luminance value and a main chrominance value; a supplementary video data receiving end for receiving a supplementary video data in a 4:4:4 sampling format, wherein the supplementary video data in the 4:4:4 sampling format comprises a sub luminance value, a first sub chrominance value, and a second sub chrominance value; a format converting module electrically connected to the main-picture video data receiving end for up-sampling the main-picture video data in the 4:2:2 to convert the main-picture video data into a main-picture video data in the 4:4:4 sampling format, wherein the main-picture video data in the 4:4:4 sampling format comprises a main luminance value, a first main chrominance value, and a second main chrominance value; a data mixer electrically connected to the format converting module and the supplementary video data receiving end for mixing the main-picture video data in the 4:4:4 sampling format with the supplementary video data in the 4:4:4 sampling format to generate a mixed video data in the 4:4:4 sampling format; and a TV encoder electrically connected to the data mixer for converting the mixed video data in the 4:4:4 sampling format into a TV video signal.

According to the preferred embodiment, a method for converting and mixing a plurality of video data without data loss is disclosed. The video data have a plurality of sampling formats, and the sampling formats at least comprise a high chrominance-sampling-rate format and a low chrominance-sampling-rate format. The claimed method includes receiving a first video data in the low chrominance-sampling-rate format and a second video data in the high chrominance-sampling-rate format; converting the first video data in the low chrominance-sampling-rate format into a first video data in the high chrominance-sampling-rate format; and mixing the first video data in the high chrominance-sampling-rate format with the second video data in the high chrominance-sampling-rate format for generating a mixed video data in the high chrominance-sampling-rate format.

In addition, the present invention discloses a method for driving a video data processing device to process at least a video data. The video data processing device has a data receiving end, a format converting module, and a data mixer. The claimed method includes utilizing the data receiving end to receive a main-picture video data in a 4:2: 2 sampling format and a supplementary video data in a 4:4:4 sampling format; utilizing the format converting module to convert the main-picture video data in the 4:2:2 sampling format into a main-picture video data in the 4:4:4 sampling format; and utilizing the data mixer to mix the main-picture video data in the 4:4:4 sampling format with the supplementary video data in the 4:4:4 sampling format for generating a mixed video data in the 4:4:4 sampling format.

It is an advantage of the present invention that the claimed data mixer mixes the main-picture video data and the supplementary video data in 4:4:4 sampling format (the highest chrominance-sampling-rate format) unlike the prior art data mixer that mixes the main-picture video data and the supplementary video data in 4:2:2 sampling format which further requires down-sampling of the supplementary video data. To sum up, the picture quality is not deteriorated according to the present invention.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a schematic diagram illustrating luminance and chrominance of a graphical layout in a 4:2:0 sampling format according to the prior art.

FIG. 2 is a schematic diagram illustrating luminance and chrominance of a graphical layout in a 4:2:2 sampling format according to the prior art.

FIG. 3 is a schematic diagram illustrating luminance and chrominance of a graphical layout in a 4:4:4 sampling format according to the prior art.

FIG. 4 is a block diagram of a prior art video data processing device.

FIG. 5 is a schematic diagram illustrating two difference prior art reduction methods.

FIG. 6 is a block diagram illustrating a video data processing device for converting and mixing video data according to one embodiment of the present invention.

FIG. 7 is a block diagram illustrating a video data processing device for converting and mixing a plurality of video data according to another embodiment of the present invention.

FIG. 8 is a flow chart illustrating the method performed by the video data processing device shown in FIG. 6.

FIG. 9 is a flow chart illustrating another method performed by the video data processing device shown in FIG. 7.

FIG. 10 is a block diagram of a video data processing device according to an actual embodiment according to the present invention.

FIG. 11 is a schematic diagram illustrating luminance and chrominance of video data shown in FIG. 10.

FIG. 12 is a schematic diagram of the data mixer shown in FIG. 10.

FIG. 13 is a block diagram of the video data processing device shown in FIG. 10 according to an actual application of the present invention.

### DETAILED DESCRIPTION

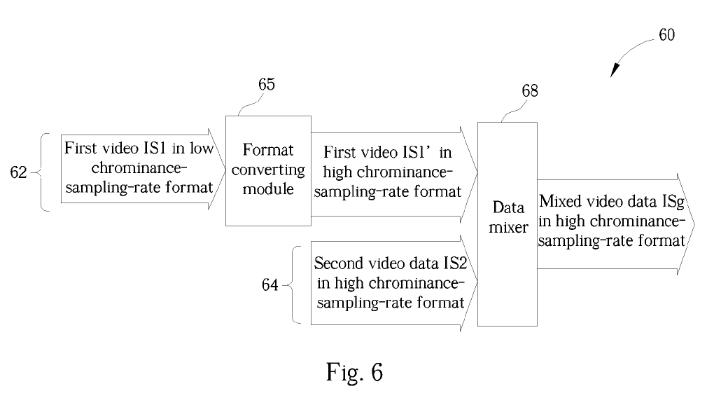

FIG. 6 is a block diagram illustrating a video data processing device 60 for converting and mixing video data according to one embodiment of the present invention. Please note that this embodiment handles two video data: a first video data IS1 and a second video data IS2, and the two video data IS1, IS2 have different sampling format, wherein one is a high chrominance-sampling-rate format and another is a low chrominance-sampling-rate format. The high chrominance-sampling-rate format has a sampling rate of the chrominance greater than that of the low chrominance-sampling-rate format. For example, referring to the MPEG-1 and MPEG-2 standards mentioned above, the high chrominance-sampling-rate format refers to the 4:4:4 sampling format and the low chrominance-sampling-rate format refers to either the 4:2:2 sampling format or the 4:2:0 sampling format. The video data processing device 60 includes a first receiving end 62, a second receiving end 64, a format converting module 65, and a data mixer 68. The first receiving end 62 is used for receiving the first video data IS1 in low chrominance-sampling-rate format, and the second receiving end 64 is used for receiving the second video data IS2 in high chrominance-sampling-rate format. The format converting module 65 is electrically connected to the first receiving end 62 for performing the up-sampling processing to convert the first video data ISI in the low chrominance-sampling-rate format into a first data ISI″ in the high chrominance-sampling-rate format. The detailed operation of the up-sampling processing will be discussed in the following paragraphs and embodiments. The data mixer 68 is electrically connected to the format converting module 65 and the second receiving end 64 for mixing the first video data IS1′ in the high chrominance-sampling-rate format with the second video data IS2 in the high chrominance-sampling-rate format and generates a mixed video data Isg in the high chrominance-sampling-rate format. Therefore, the objective of converting and mixing video data in different chrominance-sampling-rate formats is completed.

The video data processing device 60 shown in FIG. 6 has clearly disclosed a kernel feature of the present invention. That is, the video data (e.g. The first video data IS1) in low chrominance-sampling-rate format is first converted into an intermediate video data (e.g. the first video data IS1″) in high chrominance-sampling-rate format, and then the up-sampled intermediate video data is further mixed with another video data (e.g. the second video data IS2) in high chrominance-sampling-rate format. In this video data converting and mixing, there is no conversion from high chrominance-sampling-rate format to low chrominance-sampling-rate format. In other words, there is no loss of the chrominance information that leads to video quality degradation. Please note that the number of processed video data is not limited to two, as is disclosed in this embodiment. The present invention is also applicable to three or more than three inputted video data. In the case of three or more inputted video data, the video data in low chrominance-sampling-rate format is first up-sampled to become intermediate video data in high chrominance-sampling-rate format and then the mixing operation is performed. In such a way, the video quality deterioration during the mixing operation is avoided.

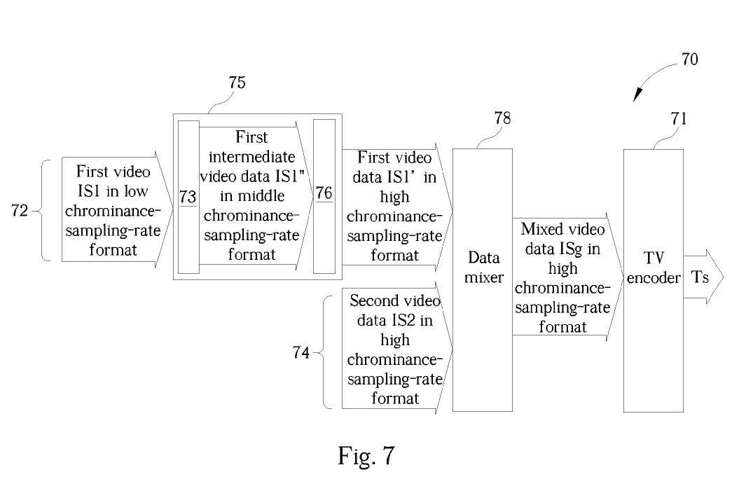

FIG. 7 is a block diagram illustrating a video data processing device 70 for converting and mixing a plurality of video data according to another embodiment of the present invention. The video data processing device 70 shown in FIG. 7 is similar to the video data processing device 60 shown in FIG. 6. The components with the same name have the same functionality, and the related operation is not repeated for simplicity. Only the newly added components will be described in details. Similar to the video data processing device 60 shown in FIG. 6, the video data processing device 70 includes a first receiving end 72, a second receiving end 74, a format converting module 75, and a data mixer 78. The first receiving end 72 is used for receiving a first video data IS1 in low chrominance-sampling-rate format, and the second receiving end 74 is used for receiving a second video data IS2 in high chrominance-sampling-rate format. The format converting module 75 converts the first video data IS1 in low chrominance-sampling-rate format into an intermediate video data IS″ in high chrominance-sampling-rate format. Then, the data mixer 78 mixes the intermediate video data IS″ in high chrominance-sampling-rate format with the second video data IS2 in high chrominance-sampling-rate format, and generates a mixed video data Isg in high chrominance-sampling-rate format.

Dissimilar to the format converting module 65 shown in FIG. 6, the format converting module 75 shown in FIG. 7 includes a first middle format converting module 73 and a second middle format converting module 76. The two inputted video data (e.g. the first video data IS1 and the second video data IS2) not only have two sampling format (e.g. the high chrominance-sampling-rate format and the low chrominance-sampling-rate format), but also have a middle chrominance-sampling-rate format that has a sampling rate lying between the sampling rate of the high chrominance-sampling-rate format and the sampling rate of the low chrominance-sampling-rate format. For example, referring to the above-mentioned basic concept for the MPEG-1 and MPEG-2 standards, the high chrominance-sampling-rate format refers to 4:4:4 sampling format, the middle chrominance-sampling-rate format refers to 4:2:2 sampling format, and the low chrominance-sampling-rate format refers to 4:2:0 sampling format. The implementation of the first and second middle format converting modules 73, 76 separates the conversion process of the first video data IS1 into two segments. That is, the first middle format converting module 73 up-samples the first video data IS1 in low chrominance-sampling-rate format for converting the original first video data IS1 into a first intermediate video data IS1″″ in middle chrominance-sampling-rate format, and then the second middle format converting module 76 further up-samples the first intermediate video data IS1″″ in middle chrominance-sampling-rate format for converting the first intermediate video data IS1″″ into a second intermediate video data IS1″ in high chrominance-sampling-rate format. The up-sampling process performed by the first and second middle format converting modules 73, 76 is identical to the previously mentioned up-sampling process, so the related description is omitted. Please note that the number of inputted video data and implemented chrominance-sampling-rate formats are not limited to what are disclosed in this preferred embodiment. The present invention is applicable as long as all the different chrominance-sampling-rate formats are converted to one sampling format with a highest sampling rate of the chrominance before the mixing operation is performed. Therefore, the same objective of preventing chrominance information from being discarded during a conversion from the high chrominance-sampling-rate format to the low chrominance-sampling-rate format is achieved. Furthermore, the video data processing device 70 further includes a TV encoder 71 that is electrically connected to the data mixer 78 for converting the mixed video data ISg in high chrominance-sampling-rate format into a TV video signal Ts which is appropriate for displaying on a TV signal reproduction device, such as a TV set. That is, in this embodiment, the video data processing device 70 further includes a TV encoder 71 comparing with the video data processing device 60 disclosed in FIG. 6.

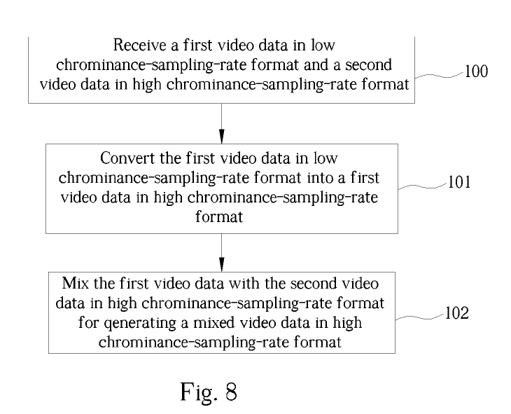

For the video data processing device 60 shown in FIG. 6, the corresponding method for converting and mixing a plurality of video data is described in the following. Please refer to FIG. 8, which is a flow chart illustrating the method performed by the video data processing device 60 shown in FIG. 6 according to the present invention.

Step 100: Receive a first video data IS1 in low chrominance-sampling-rate format and a second video data IS2 in high chrominance-sampling-rate format;

Step 101: Convert the first video data IS1 in low chrominance-sampling-rate format into an intermediate video data IS1″ in high chrominance-sampling-rate format; and

Step 102: Mix the intermediate video data IS1″ in high chrominance-sampling-rate format with the second video data IS2 in high chrominance-sampling-rate format for generating a mixed video data ISg in high chrominance-sampling-rate format.

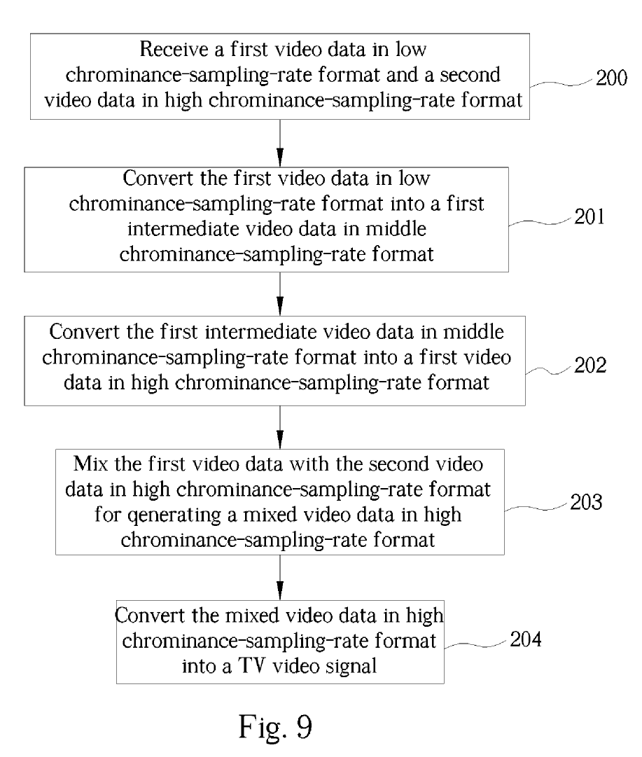

Similarly, for the video data processing device 70 disclosed in FIG. 7 which processes three different sampling formats: the high chrominance-sampling-rate format, the middle chrominance-sampling-rate format, and the low chrominance-sampling-rate format, the method for converting and mixing a plurality of video data is described in the following. Please refer to FIG. 9, which is a flow chart illustrating another method performed by the video data processing device 70 shown in FIG. 7.

Step 200: Receive a first video data IS1 in a low chrominance-sampling-rate format and a second video data IS2 in a high chrominance-sampling-rate format;

Step 201: Convert the first video data IS1 in the low chrominance-sampling-rate format into a first intermediate video data IS1″″ in a middle chrominance-sampling-rate format;

Step 202: Convert the first intermediate video data IS1″″ in the middle chrominance-sampling-rate format into a first video data IS1″ in the high chrominance-sampling-rate format;

Step 203: Mix the second intermediate video data IS1″ in the high chrominance-sampling-rate format with the second video data in the high chrominance-sampling-rate format for generating a mixed video data ISg in the high chrominance-sampling-rate format; and

Step 204: Convert the mixed video data ISg in the high chrominance-sampling-rate format into a TV video signal.

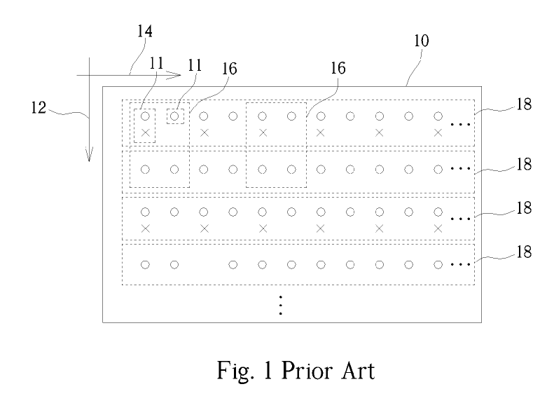

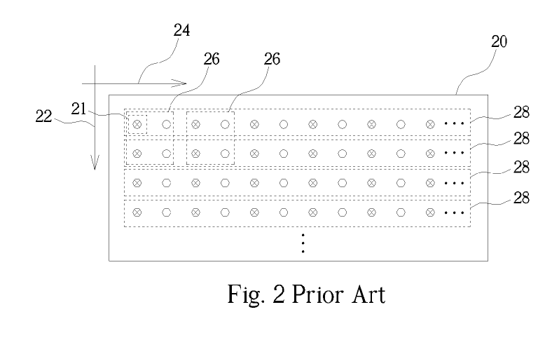

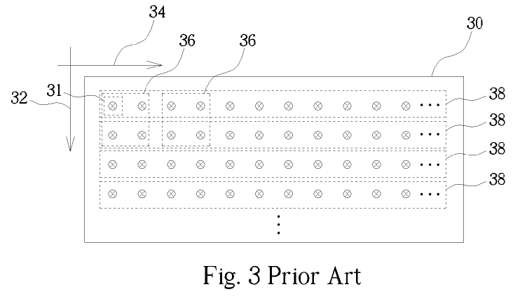

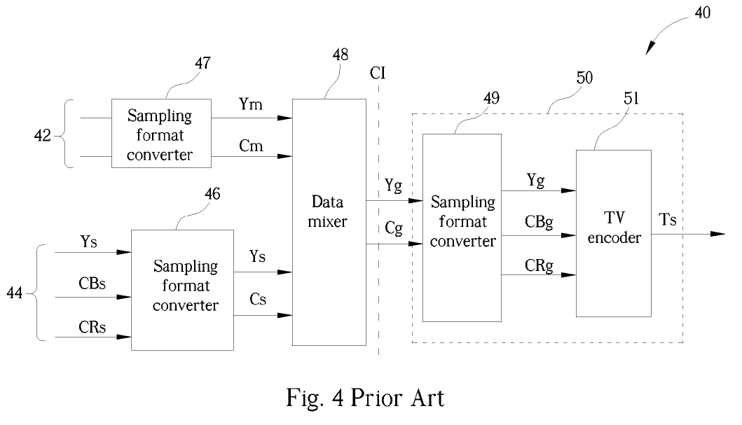

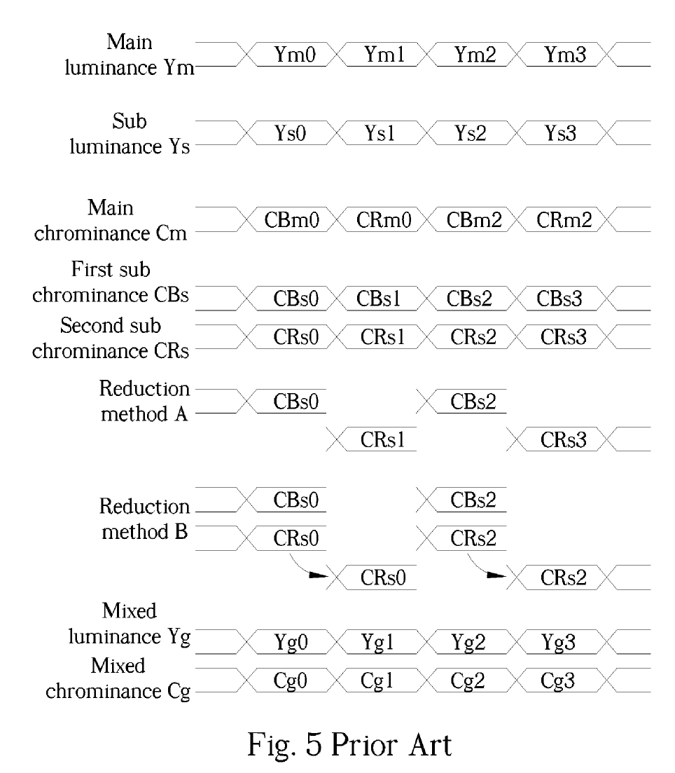

In an actual implementation, each video data processing device 60, 70 respectively shown in FIGS. 6-7 is incorporated into an MPEG-1, MPEG-2, or JPEG decoder. The first video data IS1, the second video data IS2, the mixed video data ISg, the high chrominance-sampling-rate format, the middle chrominance-sampling-rate format, and the low chrominance-sampling-rate format comply with the MPEG-1 and MPEG-2 standards, wherein the three sampling formats respectively correspond to 4:2:0 sampling format, 4:2:2 sampling format, and 4:4:4 sampling format shown in FIGS. 1-3. In a particular example, the first video data IS1 corresponds to a main-picture video data stored in a video disc (e.g. a VCD disc or a DVD disc), and the second video data IS2 corresponds to a sub-picture (SP) video data or an on-screen-display (OSD) video data stored in the video disc. For the sake of simplicity, herein the SP video data and the OSD video data are defined as a supplementary video data.

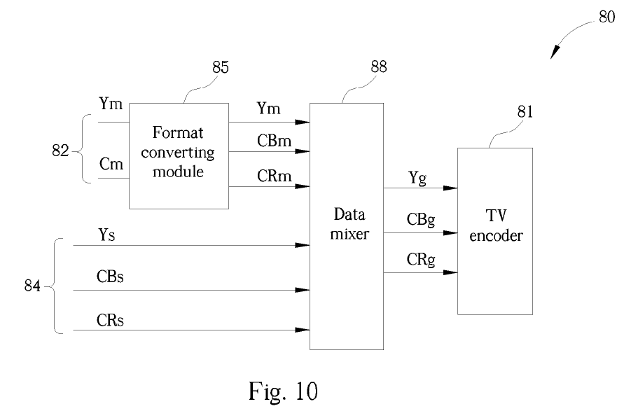

FIG. 10 is a block diagram of a video data processing device 80 according to an actual embodiment according to the present invention. Please refer to FIG. 6 in conjunction with FIG. 10. The video data processing device 80 includes a main-picture video data receiving end 82, a supplementary video data receiving end 84, a format converting module 85, a data mixer 88, and a TV encoder 81. The main-picture video data receiving end 82 is used for receiving the main-picture video data in 4:2:2 sampling format, and the supplementary video data receiving end 84 is used for receiving either the SP video data or the OSD video data in 4:4:4 sampling format. The format converting module 85 electrically connected to the main-picture video data receiving end 82 is used to up-sample the original main-picture video data in 4:2:2 sampling format for converting the original main-picture video data into an intermediate main-picture video data in 4:4:4 sampling format. The format converting module 85, therefore, can be seen as a 4:2:2 to 4:4:4 sampling format converter. The intermediate main-picture video data in 4:4:4 sampling format is further transferred to the data mixer 88, and the data mixer 88 mixes the intermediate main-picture vide data in 4:4:4 sampling format with the supplementary video data also in 4:4:4 sampling format to generate a mixed video data in 4:4:4 sampling format. In the end, the TV encoder 81 electrically connected to the data mixer 88 is activated to convert the mixed video data in 4:4:4 sampling format into a TV video signal.

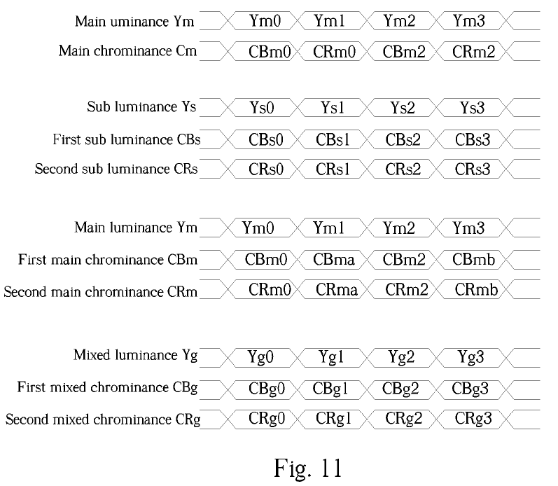

In FIG. 10, the original main-picture video data in 4:2:2 sampling format includes a luminance Ys and a chrominance Cm; the supplementary video data in 4:4:4 sampling format includes a sub luminance Ys, a first sub chrominance CBs, and a second sub chrominance CRs; the intermediate main-picture video data in 4:4:4 sampling format includes a main luminance Ym, a first sub luminance CBm, and a second sub chrominance CRm that are generated by up-sampling the original main chrominance Cm through the format converting module 85. FIG. 11 is a schematic diagram illustrating luminance and chrominance of video data shown in FIG. 10. A data stream of the main luminance Ym includes a plurality of main luminance values Ym0, Ym1, Ym2, Ym3 corresponding to different sampling points, and a data stream of the main chrominance Cm includes a plurality of main chrominance values CBm0, CRm0, CBm2, CRm3. The main chrominance values CBm0, CRm0 are obtained from the same sampling point that corresponds to the the main luminance value Ym0. The two main chrominance values CBm2, CRm2 and the luminance value Ym2, similarly, are obtained from the same sampling point. This could be easily appreciated by people skilled in this art because in the 4:2:2 sampling format, the sampling rate of the chrominance C (CR, CB) is only half of the sampling rate of the luminance Y. The aforementioned up-sampling processing makes use of a mathematical combination to increase the sampling rate of the main chrominance Cm. In this embodiment, the mathematical combination could be easily accomplished through a linear combination over the main chrominance values. Taking the interpolated first main chrominance CBma as an example, it is obtained through a linear combination of other known main chrominance values CBm0, CBm2, CBm4 according to the following equation.

CBma=A₋₂₍ₙ₋₁₎×Cbm₋₍ₙ₋₁₎+ . . . +A₋₂×CBm₀+A₀×CBm₂+ . . . +A₂ₙ×CBm₂ₙ

In the above equation, A₋₂₍₋₁₎, . . . , A₋₂, A₀, A₂, . . . , A₂ₙ are constants which represent weighting factors for defining weight of the corresponding main chrominance values CBm₋₂₍ₙ₋₁₎, . . . CBm₋₂, CBm₀, CBm₂, . . . , CBm₂ₙ contributed to the interpolated main chrominance CBma. Generally speaking, the value of the weighting factor gets bigger as the corresponding known main chrominance value is closer to the added main chrominance value CBma. For example, as shown in FIG. 11, the interpolated first main chrominance value CBma can be directly replicated from the adjacent first main chrominance value CBm0 or the adjacent first main chrominance value CBm2 (CBma=CBm0 or CBma=CBm2). In addition, the interpolated first main chrominance value CBma also can be acquired by calculating the average of two neighboring first chrominance values CBm0, CBm2. That is, CBma is equal to 0.5*CBm0 plus 0.5*CBm2. Similarly, the other interpolated first and second chrominance values CRma, CBmb, CRmb can be calculated according to the same way.

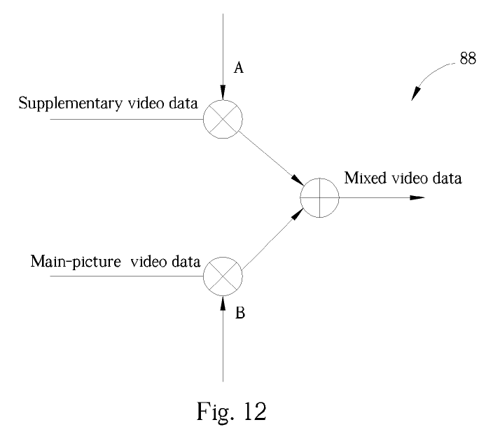

Please continue to refer to FIGS. 10 and 11, the mixed video data in 4:4:4 sampling format generated from the data mixer 88 has a mixed luminance Yg, a first mixed chrominance CBg, and a second mixed chrominance CRg. The data mixer 88 mixes the main luminance Ym, the first main chrominance CBm, and the second main chrominance CRm with the first sub luminance Ys, the first sub chrominance CBs, and the second sub chrominance CRs respectively to generate the mixed luminance Yg, the first mixed chrominance CBg, and the second mixed chrominance CRg through a mathematical combination. Please refer to FIG. 12, which is a schematic diagram of the data mixer 88 shown in FIG. 10. The kernel feature of the data mixer 88 is to mix the supplementary video data with the main-picture video data to generate a complete video data. The reference labels A and B shown in FIG. 12 represent the weighting factors of the supplementary video data and the main-picture video data, where the sum of A and B is equal to 1, i.e. A=(1−B). From this relationship, the mixed luminance Yg can be determined by the equation: Yg=A*Ys+(1−A)*Ym; the first mixed chrominance CBg can be determined by the equation: CBg=A*CBs+(1−A)*CBm; and the second mixed chrominance CRg can be determined by the equation: CRg=A*CRs+(1−A)*CRm.

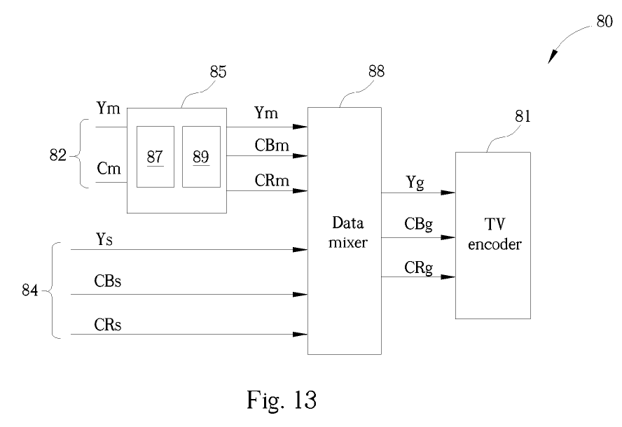

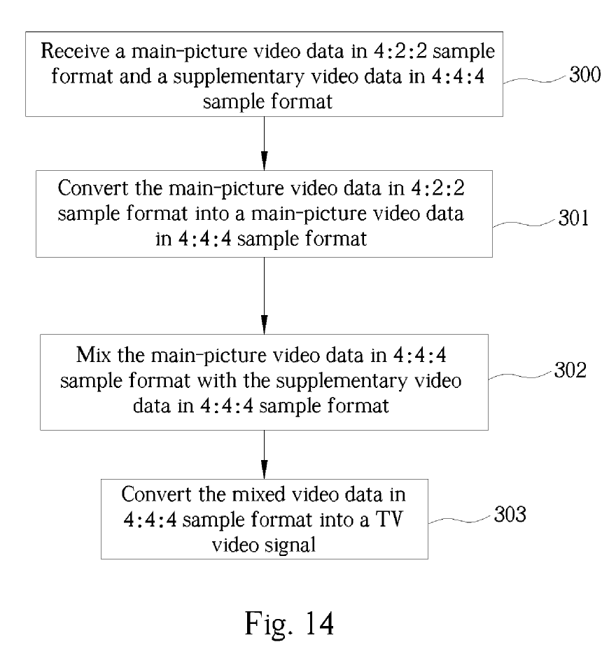

Please refer to FIG. 13, which is a block diagram of the video data processing device 80 shown in FIG. 10 according to an actual application of the present invention. As shown in FIG. 13, the format converting module 85 includes a 4:2:0 to 4:2:2 format converter 87 and a 4:2:2 to 4:4:4 format converter 89. The 4:2:0 to 4:2:2 format converter 87 is used for converting a main-picture video data in 4:2:0 sampling format stored in a disc, such as a VCD disc or a DVD disc, into a main-picture data in 4:2:2 sampling format, and then the 4:2:2 to 4:4:4 sampling format converter 89 further converts the main-picture data in 4:2:2 sampling format into a main-picture data in 4:4:4 sampling format.

According to the video data processing device 80 in the embodiment shown in FIGS. 10 and 13, the corresponding method for converting and mixing a plurality of video data includes following steps.

Step 300: Receive a main-picture video data in 4:2:2 sampling format and a supplementary video data in 4:4:4 sampling format;

Step 301: Convert the main-picture data in 4:2:2 sampling format into a main-picture video data in 4:4:4 sampling format;

Step 302: Mix the main-picture data in 4:4:4 sampling format with the supplementary video data in 4:4:4 sampling format for generating a mixed video data in 4:4:4 sampling format; and

Step 303: Convert the mixed video data in 4:4:4 sampling format into a TV video signal.

In an actual implementation using an external prior art TV encoder (e.g. a TV encoder compatible with the MPEG-1 standard), the video data inputted into the external TV encoder needs to comply with the 4:2:2 sampling format. Therefore, an additional 4:4:4 to 4:2:2 sampling format converter can be positioned after the data mixer 88 for performing the format conversion required by the external TV encoder. The present invention is fully compatible with the MPEG-1 and MPEG-2 standards and takes advantage of the TV encoder embedded in the DVD (or VCD) playback chip. In contrast to the prior art, the present invention mixes the main-picture video data and the supplementary video data in 4:4:4 sampling format (the highest chrominance-sampling-rate format) unlike the prior art that mixes the main-picture video data and the supplementary video data in 4:2:2 sampling format which further requires down-sampling of the supplementary video data. The down-sampling processing is sure to cause loss of the chrominance information, which leads to unwanted color degradation. Therefore, the picture quality is not deteriorated according to the present invention.

Those skilled in the art will readily observe that numerous modifications and alterations of the device may be made while retaining the teachings of the invention. Accordingly, that above disclosure should be construed as limited only by the metes and bounds of the appended claims.

What is claimed is:

1. A device for converting and mixing a plurality of video data, the video data having a plurality of sampling formats, the sampling formats at least comprising a high chrominance-sampling-rate format and a low chrominance-sampling-rate format, the device comprising:
a first data receiving end for receiving a first video data in the low chrominance-sampling-rate format;
a second data receiving end for receiving a second video data in the high chrominance-sampling-rate format;
a format converting module electrically connected to the first data receiving end for up-sampling the first video data to convert the first video data in the low chrominance-sampling-rate format into a first video data in the high chrominance-sampling-rate format; and
a data mixer electrically connected to the format converting module and the second data receiving end for mixing the first video data in the high chrominance-sampling-rate format with the second video data in the high chrominance-sampling-rate format to generate a mixed video data in the high chrominance-sampling-rate format.

2. The device of claim 1 further comprising a TV encoder electrically connected to the data mixer for converting the mixed video data in the high chrominance-sampling-rate format into a TV video signal.

3. The device of claim 1 being applied to an MPEG-1 decoder, an MPEG-2 decoder, or a JPEG decoder, wherein the first video data, the second video data, the mixed video data, the high chrominance-sampling-rate format, and the low chrominance-sampling-rate format comply with MPEG-1 and MPEG-2 standards.

4. The device of claim 3 wherein the first video data is a main-picture video data stored in a VCD disc or a DVD disc, and the second video data is a sub-picture (SP) video data or an on-screen display (OSD) video data stored in the VCD disc or the DVD disc.

5. The device of claim 3 wherein the high chrominance-sampling-rate format is a 4:4:4 sampling format according to the MPEG-1 and MPEG-2 standards, and the low chrominance-sampling-rate format is a 4:2:0 sampling format according to the MPEG-1 and MPEG-2 standards.

6. The device of claim 5 wherein the sampling formats further comprise a middle chrominance-sampling-rate format, the middle chrominance-sampling-rate format is a 4:2:2 sampling format according to the MPEG-1 and MPEG-2 standards, and the format converting module further comprises:
a first middle format converter for up-sampling the first video data in the low chrominance-sampling-rate format to convert the first video data into an intermediate video data in the middle chrominance-sampling-rate format; and
a second middle format converter electrically connected to the first middle format converter for up-sampling the intermediate video data in the middle chrominance-sampling-rate format to convert the intermediate video data into the first video data in the high chrominance-sampling-rate format.

7. A video data processing device comprising:
a main-picture video data receiving end for receiving a main-picture video data in a 4:2:2 sampling format, wherein the main-picture video data in the 4:2:2 sampling format comprises a main luminance value and a main chrominance value;
a supplementary video data receiving end for receiving a supplementary video data in a 4:4:4 sampling format, wherein the supplementary video data in the 4:4:4 sampling format comprises a sub luminance value, a first sub chrominance value, and a second sub chrominance value;
a format converting module electrically connected to the main-picture video data receiving end for up-sampling the main-picture video data in the 4:2:2 to convert the main-picture video data into a main-picture video data in the 4:4:4 sampling format, wherein the main-picture video data in the 4:4:4 sampling format comprises a main luminance value, a first main chrominance value, and a second main chrominance value;
a data mixer electrically connected to the format converting module and the supplementary video data receiving end for mixing the main-picture video data in the 4:4:4 sampling format with the supplementary video data in the 4:4:4 sampling format to generate a mixed video data in the 4:4:4 sampling format; and
a TV encoder electrically connected to the data mixer for converting the mixed video data in the 4:4:4 sampling format into a TV video signal.

8. The video data processing device of claim 7 wherein the data mixer respectively mixes the main luminance value with the sub luminance value, the first main chrominance value with the first sub chrominance, and the second main chrominance value with the second sub chrominance value to generate a mixed luminance value, a first mixed chrominance value, and a second mixed chrominance value through a mathematical combination.

9. The video data processing device of claim 8 wherein the mixed video data in the 4:4:4 sampling format comprises the mixed luminance value, the first mixed chrominance value, and the second mixed chrominance value.

10. The video data processing device of claim 7 further comprising a sampling format converter electrically connected to the main-picture video data receiving end for converting a main-picture video data in a 4:2:0 sampling format into the main-picture video data in the 4:2:2 sampling format.

11. The video data processing device of claim 7 wherein the main-picture video data is stored in a VCD disc or a DVD disc, and the supplementary video data is a sub-picture (SP) video data or an on-screen display (OSD) video data stored in the VCD disc or the DVD disc.

12. The video data processing device of claim 7 complying with an MPEG 1 standard, an MPEG-2 standard, or a JPEG standard.

13. A method for converting and mixing a plurality of video data without data loss, the video data having a plurality of sampling formats, the sampling formats at least comprising a high chrominance-sampling-rate format and a low chrominance-sampling-rate format, the method comprising:
receiving a first video data in the low chrominance-sampling-rate format and a second video data in the high chrominance-sampling-rate format;
converting the first video data in the low chrominance-sampling-rate format into a first video data in the high chrominance-sampling-rate format; and
mixing the first video data in the high chrominance-sampling-rate format with the second video data in the high chrominance-sampling-rate format for generating a mixed video data in the high chrominance-sampling-rate format.

14. The method of claim 13 being applied to an MPEG-1 decoder, an MPEG-2 decoder, or a JPEG decoder, wherein the first video data, the second video data, the mixed video data, the high chrominance-sampling-rate format, and the low chrominance-sampling-rate format comply with MPEG-1 and MPEG-2 standards.

15. The method of claim 14 wherein the first video data is a main-picture video data stored in a VCD disc or a DVD disc, and the second video data is a sub-picture (SP) video data or an on-screen display (OSD) video data stored in the VCD disc or the DVD disc.

16. The method of claim 14 wherein the sampling formats further comprises a middle chrominance-sampling-rate format, and the method further comprises:
converting the first video data in the low chrominance-sampling-rate format into an intermediate video data in the middle chrominance-sampling-rate format; and
converting the intermediate video data in the middle chrominance-sampling-rate format into the first video data in the high chrominance-sampling-rate formats;
wherein the middle chrominance-sampling-rate format conforms to the MPEG-1 and MPEG-2 standards.

17. The method of claim 16 wherein the high chrominance-sampling-rate format is a 4:4:4 sampling format according to the MPEG-1 and MPEG-2 standards, the middle chrominance-sampling-rate format is a 4:2:2 sampling format according to the MPEG-1 and MPEG-2 standards, and the low chrominance-sampling-rate format is a 4:2:0 sampling format according to the MPEG-1 and MPEG-2 standards.

18. A method for driving a video data processing device to process at least a video data, the video data processing device comprising a data receiving end, a format converting module, and a data mixer, the method comprising:
utilizing the data receiving end to receive a main-picture video data in a 4:2:2 sampling format and a supplementary video data in a 4:4:4 sampling format;
utilizing the format converting module to convert the main-picture video data in the 4:2:2 sampling format into a main-picture video data in the 4:4:4 sampling format; and
utilizing the data mixer to mix the main-picture video data in the 4:4:4 sampling format with the supplementary video data in the 4:4:4 sampling format for generating a mixed video data in the 4:4:4 sampling format.

19. The method of claim 18 wherein the video data processing device further comprises a TV encoder electrically connected to the data mixer, and the method further comprises utilizing the TV encoder to convert the mixed video data in the 4:4:4 sampling format into a TV video signal.

20. The method of claim 18 wherein the video data processing device further comprises a sampling format converter electrically connected to the data receiving end for converting a main-picture video data in a 4:2:0 sampling format into the main-picture video data in the 4:2:2 sampling format.

21. The method of claim 18 wherein the main-picture video data in the 4:2:2 sampling format comprises a main luminance value, a first main chrominance value, and a second main chrominance value, the supplementary video data in the 4:4:4 sampling format comprises a sub luminance value, a first sub chrominance value, and a second sub chrominance value, the main-picture video data in the 4:4:4 sampling format comprises a main luminance value, a first main chrominance value, and a second main chrominance value, and the mixed video data in the 4:4:4 sampling format comprises a mixed luminance value, a first mixed chrominance value, and a second mixed chrominance value.

22. The method of claim 21 further comprising:
utilizing the format converting module to up-sample the first main chrominance value and the second main chrominance value of the main-picture video data in the 4:2:2 sampling format for generating the first main chrominance value and the second main chrominance value of the main-picture video data in the 4:4:4 sampling format; and
utilizing the data mixer to respectively mix the main luminance value with the sub luminance value, the first main chrominance value with the first sub chrominance value, and the second main chrominance value with the second sub chrominance value for generating the mixed luminance value, the first mixed chrominance value, and the second mixed chrominance value through a mathematical combination.

23. The method of claim 18 wherein the main-picture video data is stored in a VCD disc or a DVD disc, and the sub-picture video data is a sub-picture (SP) video data or an on-screen display (OSD) video data stored in the VCD disc or the DVD disc.

24. The method of claim 18 being applied to an MPEG-1 decoder or an MPEG-2 decoder.
